(19) United States
(12) Patent Application Publication
(10) Pub. No.: US 2010/0265004 A1
(43) Pub. Date: Oct. 21, 2010

(54) Diode Switch Circuit and Switching Circuit

(75) Inventor: Yasuhiko SUZUKI, Hamura-shi (JP)

Correspondence Address: CROWELL & MORING LLP;INTELLECTUAL PROPERTY GROUP, P.O. BOX 14300, WASHINGTON, DC, 20044-4300, US

(73) Assignee: Hitachi Kokusai Electric Inc., Tokyo (JP)

(21) Appl. No.: 12/711,709

(22) Filed: Feb. 24, 2010

(30) Foreign Application Priority Data
Apr. 17, 2009 (JP) 2009-100989

(51) Int. Cl. H01P 1/15

(52) U.S. Cl. 333/103

(57) ABSTRACT

The present invention provides a PIN diode switch circuit capable of sufficiently suppressing the generation of burst noise with each switching operation. The PIN diode switch circuit is switched to a state in which a terminal (X) and a terminal (Z) are connected to each other and a state in which a terminal (Y) and the terminal (Z) are connected to each other, by forward bias and reverse bias of PIN diodes (3 and 4). In the PIN diode switch circuit, a time constant circuit (51) and a snubber circuit (54) are provided in a path of a control signal, which extends from a terminal (CX) to the PIN diode (3), and a time constant circuit (61) and a snubber circuit (64) are provided in a path of a control signal, which extends from a to/urinal (CY) to the PIN diode (4), thereby suppressing burst noise that appears at a connecting point (Q) of a capacitor (5) and a coil (6).

### CLAIM OF PRIORITY

The present invention claims priority based on Japanese Patent Application No. 2009-100989 filed in Japanese Patent Office on Apr. 17, 2009. The subject matter of this priority document is incorporated by reference herein.

### BACKGROUND OF THE INVENTION

1. Field of the Invention

The present invention relates to a high-frequency signal switch circuit using diodes, and particularly to a diode switch circuit and a switching circuit each using PIN diodes suitable for switching of an antenna in a transmitting/receiving device.

2. Description of the Related Art

A PIN diode generally has features such as a small insertion loss, satisfactory isolation (isolated state) of a signal in a non-bias state or a reverse bias state, a fast switching speed, etc. Due to the features, the PIN diode has heretofore been widely used in switching of a high-frequency signal (refer to, for example, a patent document 1 (Japanese Patent Application Laid-Open No. 2001-223551)). As a concrete example at this time, there is known, for example, a changeover switch circuit of an antenna shared between a transmitting device and a receiving device.

In the case of a transmitting/receiving device such as a transceiver, an antenna switching circuit SW is provided between an antenna ANT and transmitting and receiving circuits T and R as shown in FIG. 8. Thus, the antenna ANT is switched over to the output of the transmitting circuit T by the antenna switching circuit SW upon transmission, whereas the antenna ANT is switched over to the input of the receiving circuit R by the antenna switching circuit SW upon reception. As the antenna switching circuit SW at this time, there is used a diode switch circuit using PIN diodes as switch elements.

As is well known, the present diode switch circuit is one wherein when a diode is forward biased and thereby brought to ON (conducting state), the diode switch circuit is switched ON, whereas when a diode is reverse biased and thereby brought to OFF (cutoff state), the diode switch circuit is switched OFF. If the PIN diodes are used at this time, then the characteristics desirable for a switch circuit, which is small in insertion loess when turned ON, satisfactory in signal's isolation when turned OFF, and fast in switching speed, can be obtained as described above.

FIG. 5 is one example of a diode switch circuit using PIN diodes, according to a prior art. This prior art is one which is provided with a terminal X, a terminal Y and a terminal Z and in which in one switched state, the terminals X and Z are connected to each other whereas in the other switched state, the terminals Y and Z are connected to each other. Thus, this is one wherein a so-called two-branch type switch circuit is configured by two PIN diodes 1 and 2. Therefore, the terminal X is connected to the terminal Z through capacitors 10 and 11 on a high-frequency basis, and the terminal Y is connected to the terminal Z through capacitors 20 and 21.

Here, the PIN diode 1 lying on the X side has an anode connected to a connecting point of the capacitors 10 and 11. A cathode thereof is grounded via a capacitor 12 on a high-frequency basis and grounded via a coil (inductance element) 13 on a dc basis. On the other hand, a control terminal CX lying on the X side is connected to the connecting point of the capacitors 10 and 11 through a resistor 15 and a coil 16 on a DC basis.

The PIN diode 2 lying on the Y side has an anode connected to a connecting point of the capacitor 20 and the capacitor 21. A cathode thereof is grounded via a capacitor 22 on a high-frequency basis and grounded via a coil 23 on a DC basis. On the other hand, a control terminal CY lying on the Y side is connected to the connecting point of the capacitors 20 and 21 through a resistor 25 and a coil 26 on a DC basis.

Assuming now that a switching control signal S (refer to FIG. 7) of a voltage E (E>0) is applied from an unillustrated switch control section to the control terminal CX lying on the X side, the PIN diode 1 lying on the X side is forward biased through the resistor 15 and the coil 16. As a result, the PIN diode 1 is turned ON to bring the connecting point of the capacitor 10 and the capacitor 11 to ground on a high-frequency basis, thereby bringing the terminal X to a ground state on a high-frequency basis. Consequently, this is made equivalent to the terminal X being isolated from the terminal Z. Thus, at this time, the terminal Y is connected to the terminal Z.

When the switching control signal S of the voltage E (E>0) is applied to the control terminal CY lying on the Y side to the contrary, the PIN diode 2 lying on the Y side is forward biased through the resistor 25 and the coil 26. As a result, the PIN diode 2 is turned ON to bring the connecting point of the capacitor 20 and the capacitor 21 to ground on a high-frequency basis, thereby bringing the terminal Y to a ground state on a high-frequency basis. Therefore, this is made equivalent to the terminal Y being isolated from the terminal Z this time. Thus, at this time, the terminal X is connected to the terminal Z, thereby making it possible to obtain an operation as a two-branch type switch circuit. The voltage E at this time is assumed to be a voltage value enough to bring the PIN diodes 1 and 2 to a saturated conduction region.

Next, FIG. 6 is another example of a diode switch circuit using PIN diodes, according to a prior art. This is also one wherein a two-branch type switch circuit is configured by two PIN diodes 3 and 4. First, a terminal X is connected to a Z through a capacitor 30 and the PIN diode 3, and a capacitor 5 on a high-frequency basis. Next, a terminal Y is connected to the terminal Z through a capacitor 40 and the PIN diode 4, and the capacitor 5 on a high-frequency basis.

At this time, a connecting point of the PIN diodes 3 and 4 and the capacitor 5 is connected to a common potential point by a coil 6, so that the connecting point is grounded on a DC basis. The connecting point is however in a state of being isolated therefrom on a high-frequency basis. A control terminal CX lying on the X side is connected to a connecting point of the capacitor 30 and the PIN diode 3 through a resistor 32 and a coil 33 on a DC basis. Further, a control terminal CY lying on the Y side is connected to a connecting point of the capacitor 40 and the PIN diode 4 through a resistor 42 and a coil 43.

Thus, if a switching control signal S of a voltage E (>0) is applied to the control terminal CX lying on the X side, then the PIN diode 3 lying on the X side is turned ON to connect between the terminals X and Z on a high-frequency basis. If the voltage E is applied to the control terminal CY lying on the Y side, then the PIN diode 4 lying on the Y side is turned ON to connect between the terminals Y and Z on a high-frequency basis this time, whereby the present diode switch circuit is operated as a two-branch type switch circuit.

It cannot be said that in the above-described prior art, consideration has been given to the point that the switching control signal of the diode switch circuit changes stepwise. This is because noise developed on a burst basis due to the change in the switching control signal appears at the output terminal of the switch circuit in this case. In the case of the prior art described in FIG. 5, for example, a harmonic component contained in the switching control signal S applied to each of the control terminals CX and CY appears at the terminal Z through the capacitors 11 and 21 as burst noise B as shown in FIG. 7.

In the case of the prior art described in FIG. 6, surge currents flow into ground from the PIN diodes 3 and 4 via the coil 6 by the control voltage applied to the control terminals CX and CY. Therefore, a ringing voltage occurs due to an inductance component of the coil 6. This appears at the terminal Z through the capacitor 5 and becomes the burst noise B as shown in FIG. 7. If the antenna ANT has been connected to the terminal Z as shown in FIG. 8 at this time, the burst noise is then radiated into space from the antenna ANT as being spurious. As a result, when the burst noise is captured by peripheral devices or peripherals P such as other wireless device, a receiving section of a local device, etc. lying in the neighborhood of the periphery of the antenna ANT, squelch functions operate at the respective devices.

The PIIN diode switch circuit according to the prior art is hence accompanied by a problem in that that when peripheral equipment exist, they are caused to induce malfunctions. The present invention has been made in view of the problem of the prior art.

An object of the present invention is thus to provide a PIN diode switch circuit capable of sufficiently suppressing the occurrence of burst noise with a switching operation.

### SUMMARY OF THE INVENTION

The above object is achieved by providing a diode switch circuit of a system for using PIN diodes as switch elements and supplying switching signals each changed stepwise to the switch elements to thereby allow the switch elements to perform switching operations, comprising snubber circuits and time constant circuits respectively provided in supply paths of the switching signals, wherein each of the snubber circuits absorbs a spike-like high voltage contained in the switching signal and wherein each of the time constant circuits makes a change in the switching signal gentle.

At this time, each of the PIN diodes may be connected between the supply path of the switching signal and ground. The PIN diode may be connected in series with the supply path of the switching signal.

At this time as well, the snubber circuit may comprise a series circuit of a resistor and a capacitor connected between the supply path of the switching signal and a positive potential point. The time constant circuit may comprise a series circuit of a resistor and a capacitor connected in series with the supply path of the switching signal.

Further, at this time, there may be provided transistors each having an emitter connected to a positive potential point through a resistor, a collector connected to a negative potential point through a resistor and a base supplied with the switching signal. The snubber circuit may comprise a series circuit of a resistor and a capacitor connected in parallel between the base of the transistor and the positive potential point. The time constant circuit may comprise a series circuit of a resistor and a capacitor connected in series with a path extending from the collector of the transistor and the PIN diode.

Next, the above object is achieved even by providing a switching circuit comprising a plurality of diode switch circuit units of systems for using PIN diodes as switch elements and supplying switching signals each changed stepwise to the switch elements to thereby allow the switch elements to perform switching operations, and a switching signal cooperating circuit inputted with switching signals for the respective diode switch circuit units, wherein the switching signal cooperating circuit disperses timings of switching signals outputted to the respective units according to the input switching signals and performs switching operations of the diode switch circuit units at timings different every unit.

At this time, there may be provided snubber circuits and time constant circuits in supply paths of the switching signals for the respective diode switch circuit units. Each of the snubber circuits may absorb a spike-like high voltage contained in each of the switching signals. Each of the time constant circuits may make a change in the switching signal gentle.

At this time as well, the snubber circuit may comprise a series circuit of a resistor and a capacitor connected between the supply path of the switching signal and a positive potential point. The time constant circuit may comprise a series circuit of a resistor and a capacitor connected in series with the supply path of the switching signal.

The above object is achieved even by providing a switching circuit comprising a first unit group and a second unit group each including a plurality of diode switch circuit units of systems for using PIN diodes as switch elements and supplying switching signals each changed stepwise to the switch elements to thereby allow the switch elements to perform switching operations; a first switching signal cooperating circuit inputted with switching signals for respective units of the first unit group; and a second switching signal cooperating circuit inputted with switching signals for respective units of the second unit group, wherein the first switching signal cooperating circuit disperses timings of the switching signals outputted to the respective units of the first unit group according to the switching signals inputted to the respective units of the first unit group and performs switching operations of the units of the first unit group at timings different at the respective units, and wherein the second switching signal cooperating circuit disperses timings of the switching signals outputted to the respective units of the second unit group according to the switching signals inputted to the respective units of the second unit group and performs switching operations of the units of the second unit group at timings different at the respective units.

At this time, there may be provided snubber circuits and time constant circuits respectively provided in supply paths of the switching signals for the respective units of the first unit group and the second unit group. Each of the snubber circuits may absorb a spike-like high voltage contained in each of the switching signals. Each of the time constant circuits may make a change in the switching signal gentle.

At this time as well, the snubber circuit may comprise a series circuit of a resistor and a capacitor connected between the supply path of the switching signal and a positive potential point. The time constant circuit may comprise a series circuit of a resistor and a capacitor connected in series with the supply path of the switching signal.

According to the present invention, since the generation of burst noise with a switching operation is suppressed, there is no fear of occurrence of a malfunction in a peripheral device even though the switching operation is performed. Thus, a diode switch circuit can be used without concern for the presence of the peripheral device when applied to the switching of an antenna.

Other features and advantages of the present invention will become apparent upon a reading of the attached specification.

### BRIEF DESCRIPTION OF THE DRAWINGS

The organization and manner of the structure and operation of the invention, together with further objects and advantages thereof, may best be understood by reference to the following description, taken in connection with the accompanying drawings, wherein like reference numerals identify like elements in which:

FIG. 1 is a circuit diagram showing a first embodiment of a diode switch circuit according to the present invention;

FIG. 2 is a waveform diagram for describing the operation of the first embodiment of the diode switch circuit according to the present invention;

FIG. 3 is a circuit diagram showing a second embodiment of a diode switch circuit according to the present invention and a waveform diagram thereof;

FIG. 4 is a circuit diagram showing a third embodiment of a diode switch circuit according to the present invention and a waveform diagram thereof;

FIG. 5 is a circuit diagram illustrating one example of a diode switch circuit according to a prior art;

FIG. 6 is a circuit diagram depicting another example of a diode switch circuit according to a prior art;

FIG. 7 is a waveform diagram for describing burst noise generated in a diode switch circuit; and

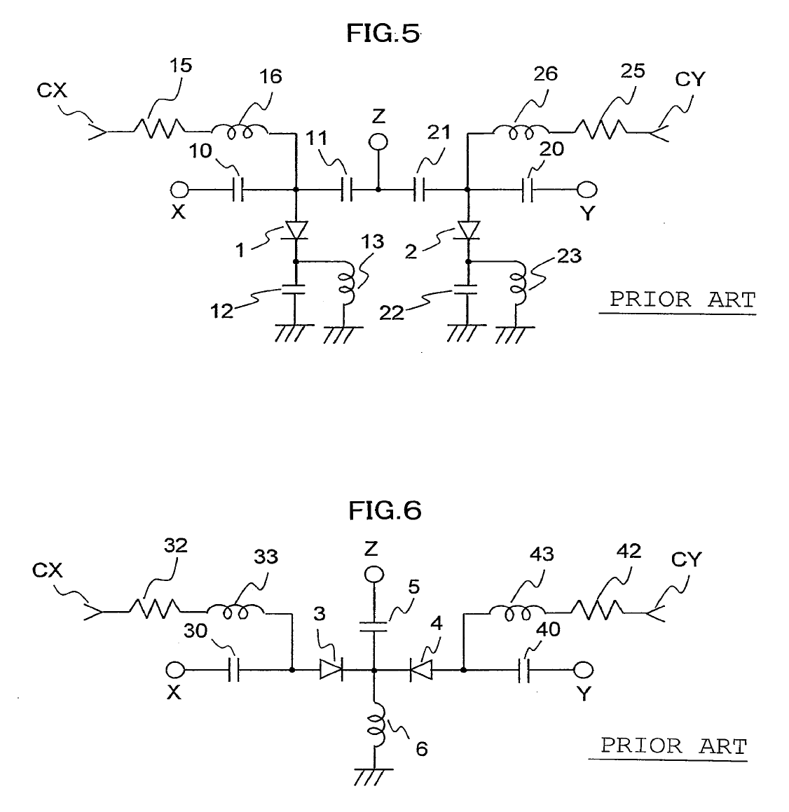

FIG. 8 is a block diagram for describing an example to which a diode switch circuit is applied.

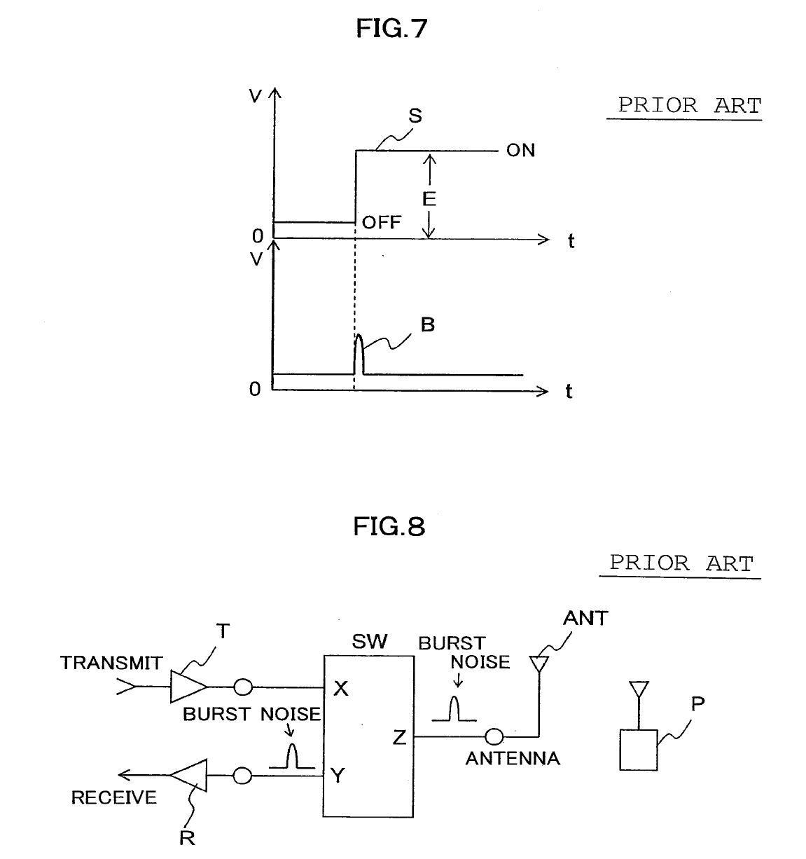

### DETAILED DESCRIPTION OF THE PREFERRED EMBODIMENTS

Diode switch circuits according to the present invention will hereinafter be described in detail in accordance with embodiments illustrated in the accompanying drawings.

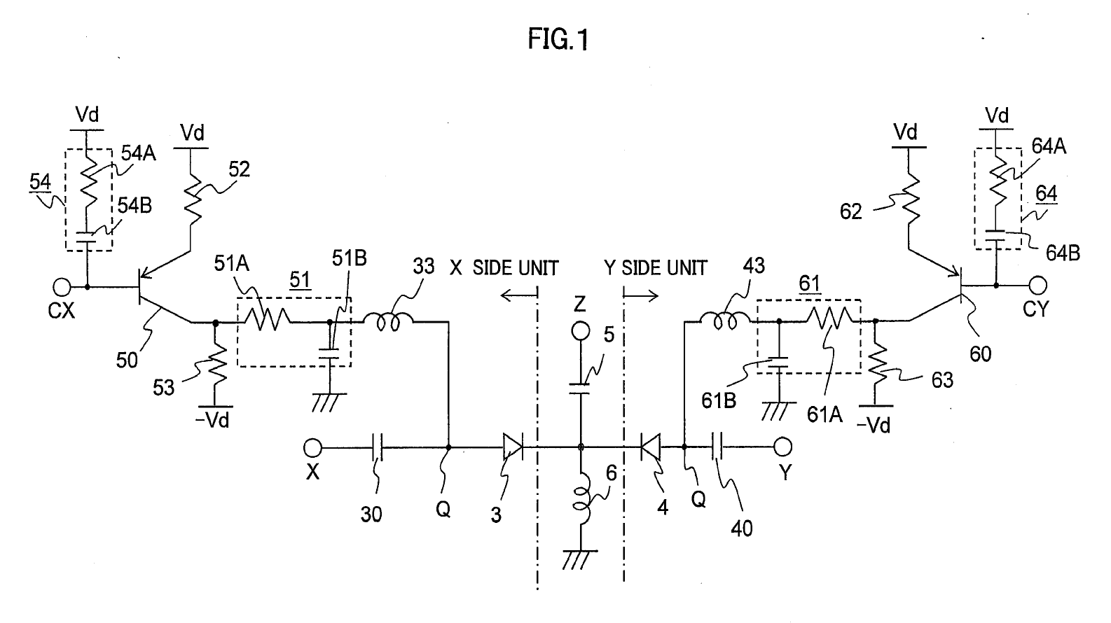

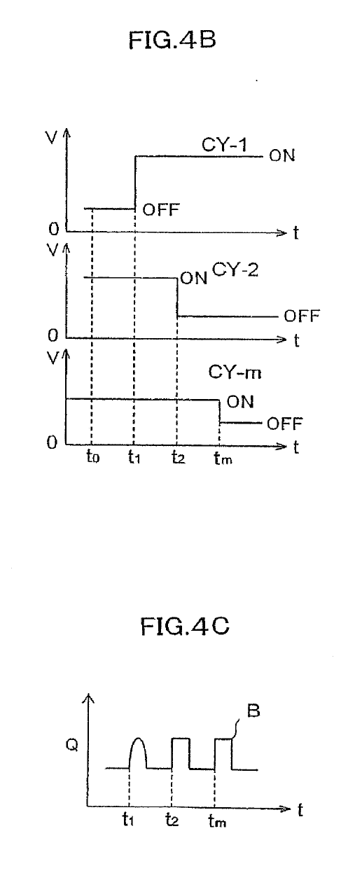

FIG. 1 shows a first embodiment of the present invention. This is one embodiment where the present invention is applied to the PIN diode switch circuit described in FIG. 6. Thus, to/urinal Z, terminals X and Y, PIN diodes 3 and 4, a capacitor 5, a coil 6, capacitors 30 and 40, coils 33 and 43 and control terminals CX and CY are the same as those shown in FIG. 6. In the embodiment of FIG. 1, however, the control terminals CX and CY are connected to their corresponding bases of transistors 50 and 60. The coils 33 and 43 are respectively connected to time constant circuits 51 and 61. The time constant circuits 51 and 61 comprise RC time constant circuits comprised of resistors 51A and 61A and capacitors 51B and 61B respectively.

Here, a voltage Vd is applied to an emitter of the transistor 50 lying on the X side through a resistor 52, and a voltage −Vd is applied to a collector thereof through a resistor 53. Then, a snubber circuit 54 comprised of a series circuit of a resistor 54A and a capacitor 54B is connected between a base of the transistor 50 and the voltage Vd. Similarly even on the Y side, the voltage Vd is applied to an emitter of the transistor 60 through a resistor 62, and the voltage −Vd is applied to a collector thereof through a resistor 63. Then, a snubber circuit 64 comprised of a series circuit of a resistor 64A and a capacitor 64B is connected between a base of the transistor 60 and the voltage Vd.

The operation of the first embodiment shown in FIG. 1 will next be explained.

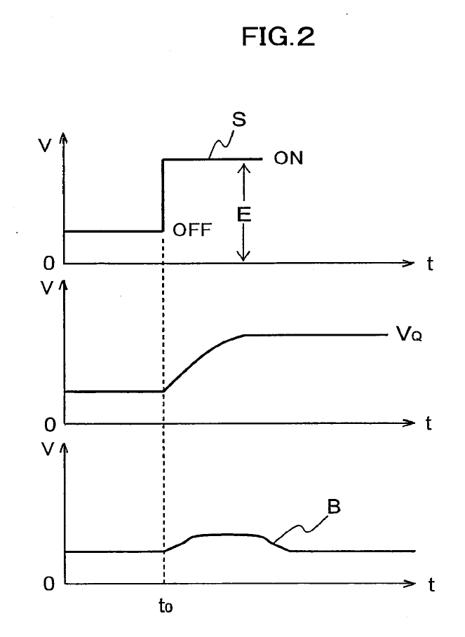

First assume that a switching control signal S of a voltage E (>0) is applied to the control terminal CX provided on the X side at a time tO as shown in FIG. 2. In doing so, the transistor 50 is turned ON so that the voltage of the base thereof rises to a voltage E. Since the voltage E is applied to an anode of the X side PIN diode 3 through the time constant circuit 51 and the coil 33 as a control signal, the PIN diode 3 is forward biased. As a result, the X side PIN diode 3 is turned ON to connect between the terminals X and Z on a high-frequency basis.

At this time, the snubber circuit 54 is connected to the control terminal CX. The time constant circuit 51 is provided between the collector of the transistor 50 and the coil 33. Thus, assume that a spike-like high voltage is contained in the control signal S. Since the snubber circuit 54 is however provided in this case, the spike-like high voltage is suppressed by the snubber circuit 54. Accordingly, the control voltage containing no spike-like high voltage can be applied to the base of the transistor 50 as a control signal.

This is the same even on the Y side. If a positive voltage +V is applied to the Y side control terminal CY, the Y side PIN diode 4 is brought into conduction. Therefore, the terminals Y and Z are connected to each other on a high-frequency basis this time, thus resulting in the PIN diode 4 being operated as a two-branch switch circuit. This is the same as the X side even at this time. Thus, the control voltage containing no spike-like high voltage can be applied to the base of the transistor 60 as a control signal.

In the present embodiment, the switching control signal of the voltage E that has appeared at the collector of the transistor 50 is applied to the coil 33 after having passed through the time constant circuit 51 without being applied to the PIN diode 3 through the coil 33 as it is. Then, the switching control signal is applied to the PIN diode 3 through the coil 33. As a result, a control voltage VQ that appears at a connecting point Q of the capacitor 30 and the PIN diode 3 gently rises with a delay time determined by the time constant of the time constant circuit 51 as shown in FIG. 2 without immediately rising in a step form at the time tO. This is the same even when the control voltage VQ falls, and gently falls in the same manner.

Therefore, the transition of the PIN diode 3 to a cut-off state and a conducting state also becomes gentle and hence a change in the current flowing through the coil 6 also becomes gentle. Thus, a ringing voltage generated by an inductance component is suppressed, so that burst noise B gently changes and a peak voltage value is suppressed, as shown in FIG. 2. This is the same even on the Y side and a change in the current flowing from the PIN diode 4 to the coil 6 also becomes gentle. Therefore, a ringing voltage generated by an inductance component is suppressed. Consequently, burst noise B gently changes and a peak voltage value is suppressed, as shown in FIG. 2 in like manner.

Thus, according to the first embodiment, there is no potential for noise generated on a burst basis due to a change in switching control signal to appear at an output terminal of a switch circuit. Consequently, even when the switching control signal contains a harmonic component, burst noise does not occur. It is thus possible to perform a switching operation without the fear of a malfunction even when a peripheral device exists. Since there is also no fear of the occurrence of a ringing voltage due to the inductance component of the coil 6, it is possible to perform the switching operation without the fear of the malfunction even when the peripheral device exists.

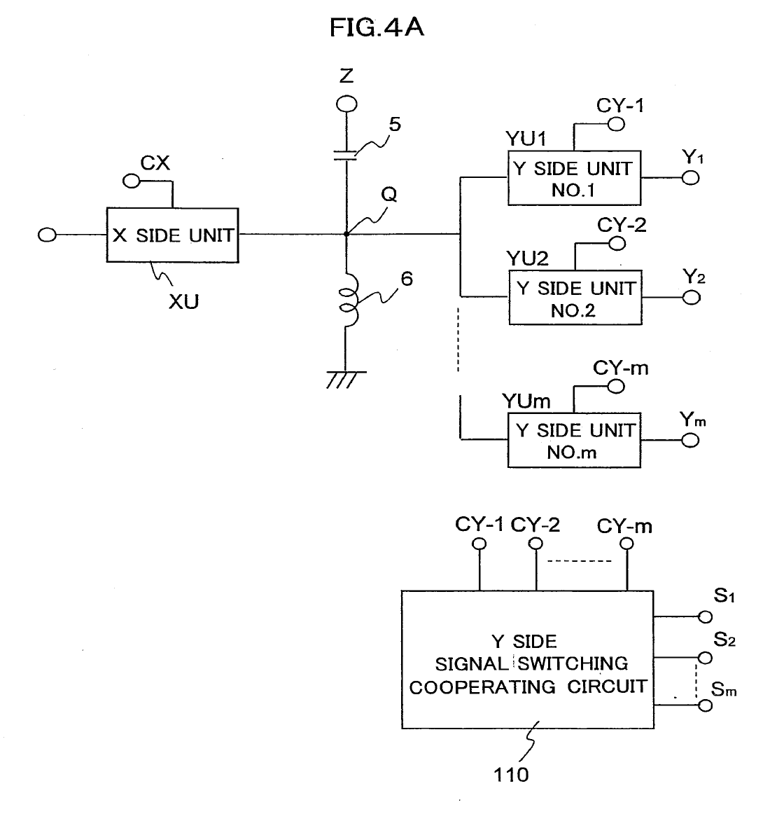

Incidentally, the above description has been made with the case where the present invention is applied to the diode switch circuit according to the prior art of FIG. 6 being taken as the first embodiment. The first embodiment may however be configured by applying the present invention to the diode switch circuit according to the prior art of FIG. 5. In this case, the control terminal CX and the coil 33 shown in FIG. 1 are provided instead of the control terminal CX and the coil 16 on the X side of FIG. 5. On the Y side, the control terminal CY and the coil 43 may be provided instead of the control terminal CY and the coil 26.

Other embodiments of the present invention will next be explained.

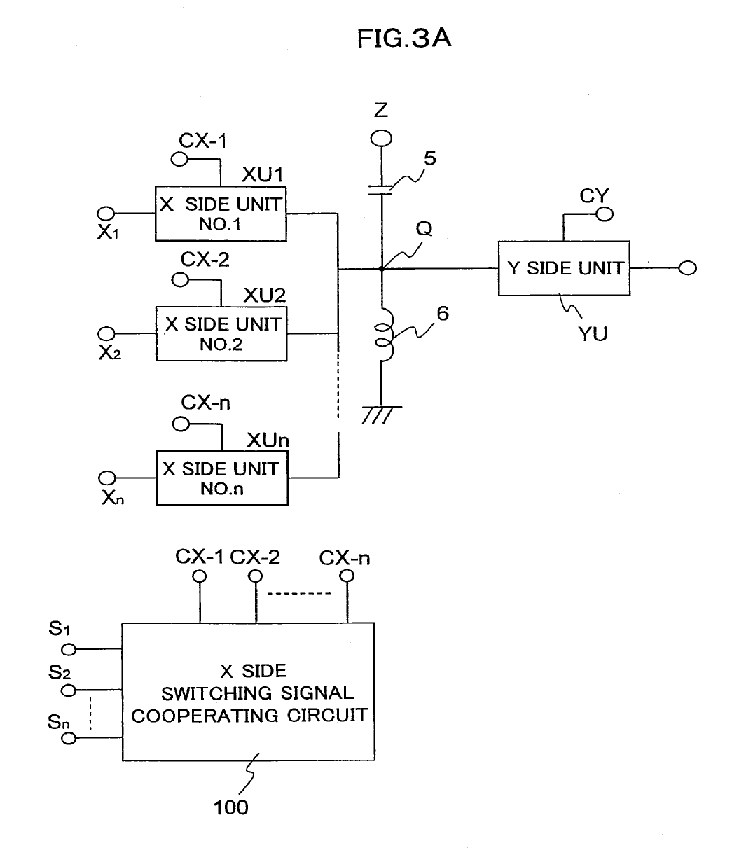

The first embodiment corresponds to the case in which the terminals X and Y are respectively intended for one diode switch circuit. Each of the embodiments to be explained below corresponds to a case where one of terminals X and Y is intended for a plurality of diode switch circuits or both of the terminals X and Y are intended for a plurality of diode switch circuits. In this case, firstly, in FIG. 1, a configuration as seen to the left side from a one-dot chain line lying on the left side is taken as an X side unit, and a configuration as seen to the right side from a one-dot chain line lying on the right side is taken as a Y side unit. Then, these X and Y side units are combined with one terminal Z, one capacitor 5 an one coil 6 as shown in FIG. 3A.

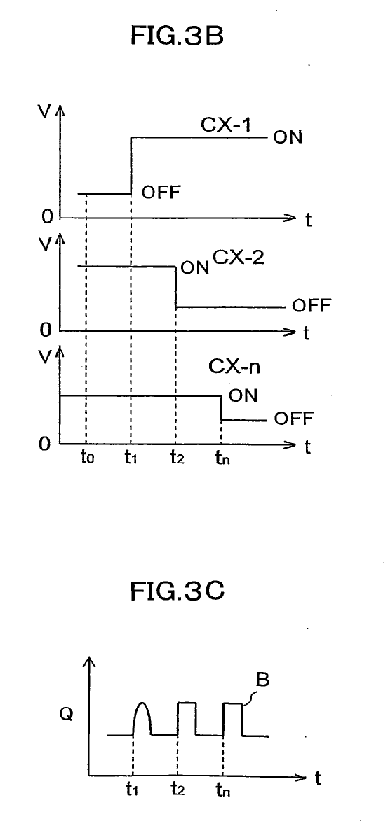

Now, FIG. 3A shows a second embodiment of the present invention. This is one embodiment where the number of X side units is n (where n≧2). FIG. 4A shows a third embodiment of the present invention. This is one embodiment where the number of Y side units is m (where m≧2). At this time, there is also mentioned, as the third embodiment of the present invention, an embodiment where the numbers of X side units and Y side units are both plural. Illustrations thereof will however be omitted.

In FIG. 3A, an X side switching signal cooperating circuit 100 is equipped with n inputs and n outputs. When two or more kinds of signals are simultaneously generated within switching control signals S1, S2, . . . Sn, the X side switching signal cooperating circuit 100 takes one kind of signal (e.g., switching control signal S1) thereof as a reference as shown in FIG. 3B. The X side switching signal cooperating circuit 100 functions to delay the remaining signals (switching control signals S2, . . . Sn) sequentially and output them from terminals CX-1, CX-2, . . . CX-n.

At this time, the switching control signals S1, S2, . . . Sn and the terminals CX-1, CX-2, . . . CX-n respectively correspond to the X side units XU1, XU2, . . . XUn. Namely, the switching control signal S1 is of a control signal for the X side unit XU1, the switching control signal S2 is of a control signal for the X side unit XU2, and the switching control signal Sn is of a control signal for the X side unit XUn. Firstly, the terminal CX-1 is connected to a control to/urinal CX-1 of the X side unit XU1, the terminal CX-2 is connected to a control terminal CX-2 of the X side unit XU2, and the terminal CX-n is connected to a control terminal CX-n of the X side unit XUn.

Next, in FIG. 4A, a Y side switching signal cooperating circuit 110 is equipped with m inputs and m outputs. When two or more kinds of signals are simultaneously generated within switching control signals S1, S2, . . . Sm, the Y side switching signal cooperating circuit 110 takes one kind of signal (e.g., switching control signal S1) thereof as a reference. Then, the Y side switching signal cooperating circuit 110 functions to delay the remaining signals (switching control signals S2, . . . Sm) sequentially and output them from terminals CY-1, CY-2, . . . CY-m. Even in the present embodiment, the switching control signals S1, S2, . . . Sm and the terminals CY-1, CY-2, . . . CY-m respectively correspond to the Y side units YU1, YU2, . . . YUm.

Namely, the switching control signal S1 is of a control signal for the Y side unit YU1, the switching control signal S2 is of a control signal for the Y side unit YU2, and the switching control signal Sm is of a control signal for the Y side unit YUm. The terminal CY-1 is connected to a control terminal CY-1 of the Y side unit YU1, the terminal CY-2 is connected to a control terminal CY-2 of the Y side unit YU2, and the terminal CY-m is connected to a control terminal CY-m of the Y side unit YUm.

The operation of the second embodiment shown in FIG. 3A will next be explained.

Now assume that at a given time tO, the switching control signal S1 is OFF and the switching control signals S2 and Sn are both ON. In this case, in the diode switch circuit, terminals X2 and Xn are connected to the terminal Z, and a terminal X1 is isolated from the terminal Z. Now assume that at a given time t1 subsequent to the time tO, the switching control signal S1 is changed to ON and the switching control signals S2 and Sn are both changed to OFF.

At this time, when the two or more kinds of signals are simultaneously generated within the switching control signals S1, S2, . . . Sn as described above, the X side switching signal cooperating circuit 100 functions to take one kind of signal (e.g., signal changed from OFF to ON) as a reference, sequentially delay the remaining signals and output them from the terminals CX-1, CX-2, . . . CX-n. Thus, in this case, the signal changed from OFF to ON, i.e., the switching control signal S1 is taken as the reference. At this time, the corresponding control signal is generated from the terminal CX-1 immediately at the time t1. Thereafter, the corresponding control signals are sequentially generated from the terminals CX-2 and CX-n with a predetermined delay time τ as shown in FIG. 3B.

Namely, in this case, the control signal is first generated from the terminal CX-1 at the time t1. Next, the control signal is generated from the terminal CX-2 at a time t2 (=t1+τ). At a time t3 (=t2+2τ), the control signal is generated from the terminal CX-n. By doing so, at the time t1, the terminal X1 is first connected to the terminal Z as its result. Thereafter, the terminal X2 is isolated from the terminal Z at the time t1. Further, at the time t2 subsequent to the time t1, the terminal X3 is isolated from the terminal Z so that the switching operation is completed.

Incidentally, the intensity of burst noise generated upon the above switching operation may be considered to be approximately identical at each unit. Thus, if all of the X side units XU1, XU2 and XUn are switched simultaneously at the same timing, i.e., time t1 at this time, then the intensity of burst noise B that appears at a connecting point Q of the capacitor 5 and the coil 6 results in the burst noise generated separately at the three X side units XU1, XU2 and XUn being added together. It can thus be easily imagined that the intensity thereof would lead to an extremely high level.

In the embodiment of FIG. 3A, however, the switching operations are performed in dispersed form at discrete timings as shown in FIG. 3B. Consequently, even though the burst noise are generated by the switching operations, they are not added together. As shown in FIG. 3C, at the respective units, they appear as a plurality of burst noise B dispersed with remaining at the original level, at different timings, i.e., respective times t1, t2, . . . tn. Thus, according to the present embodiment, the level of burst noise associated with each switching operation can be suppressed, thus resulting in enabling avoidance of a fear of the occurrence of a malfunction in a peripheral device.

The operation of the third embodiment shown in FIG. 4 will next be described.

Now assume that in a manner similar to the second embodiment, at a given time tO, a switching control signal S1 is OFF and switching control signals S2 and Sn are both ON. In doing so, terminals Y2 and Ym are connected to a terminal Z, and a terminal Y1 is isolated from the terminal Z in this case. Then assume that at a given time t1 subsequent to the time tO, the switching control signal S1 is changed to ON and the switching control signals S2 and Sm are both changed to OFF.

Thus, when two or more kinds of signals are simultaneously generated within the switching control signals S1, S2, . . . Sm, the Y side switching signal cooperating circuit 110 also functions to take one kind of signal (e.g., signal changed from OFF to ON) of these signals as a reference, sequentially delay the remaining signals and output them from the terminals CY-1, CY-2, . . . CY-m as described above. Thus, in this case, the signal changed from OFF to ON, i.e., the switching control signal S1 is taken as the reference. In regard to this, the corresponding control signal is generated from the CY-1 immediately at the time t1. Thereafter, the corresponding control signals are sequentially generated from the terminal CY-2 and the terminal CY-m with a predetermined delay time τ as shown in a waveform diagram D.

Namely, even in this case, the control signal is first generated from the terminal CY-1 at the time t1. Next, the control signal is generated from the terminal CY-2 at a time t2 (=t1+τ). At a time t3 (=t2+2τ), the control signal is generated from the terminal CY-m. Thus, at the time t1, the terminal Y1 is first connected to the terminal Z as its result. Thereafter, the terminal Y2 is isolated from the terminal Z at the time t1. Then, at the time t2 subsequent to the time t1, the terminal Y3 is isolated from the terminal Z so that the switching operation is completed.

Even in this case, the intensity of burst noise generated upon the switching operation may be considered to be approximately identical at each unit. Thus, if all of the Y side units YU1, YU2 and YUm are switched simultaneously at the same time t1 at this time, then the intensity of burst noise B that appears at a connecting point Q of a capacitor 5 and a coil 6 is likely to reach an extremely high level by adding the burst noise generated separately at the three Y side units YU1, YU2 and YUm.

In the third embodiment, however, the switching operations are performed in dispersed form at discrete timings as shown in FIG. 4B. Consequently, even though the burst noise are generated by the switching operations, they are not added together. As shown in FIG. 4C, they appear as a plurality of burst noise B dispersed with remaining at the original level, at different timings at the respective units. Thus, the level of burst noise associated with each switching operation can be suppressed even by the third embodiment, thus resulting in enabling the elimination of a fear of the occurrence of a malfunction in a peripheral device.

Incidentally, the occurrence of the burst noise becomes a problem in the diode switch circuit where the peripheral device such as other wireless device, the receiving section of the local device or the like exists principally as described above. This is because the squelch function operates in the peripheral device in this case. Thus, when the peripheral device is placed under the control of the above-described switch control section, e.g., when the receiving section of the local device is of the peripheral device or of a wireless device of a corresponding station being synchronized with the local device, the switch control section may supply a switching signal to the peripheral device in such a manner that the squelch function of the peripheral device is turned OFF when the PIN diode switch circuit is being switched.

While the preferred forms of the present invention have been described, it is to be understood that modifications will be apparent to those skilled in the art without departing from the spirit of the invention. The scope of the invention is to be determined solely by the following claims.

What is claimed is:

1. A diode switch circuit of a system for using PIN diodes as switch elements and supplying switching signals each changed stepwise to the switch elements to thereby allow the switch elements to perform switching operations, comprising:
snubber circuits and time constant circuits respectively provided in supply paths of the switching signals,
wherein each of the snubber circuits absorbs a spike-like high voltage contained in the switching signal, and
wherein each of the time constant circuits makes a change in the switching signal gentle.

2. The diode switch circuit according to claim 1, wherein each of the PIN diodes is connected between the supply path of the switching signal and ground.

3. The diode switch circuit according to claim 1, wherein the PIN diode is connected in series with the supply path of the switching signal.

4. The diode switch circuit according to claim 1, wherein the snubber circuit comprises a series circuit of a resistor and a capacitor connected between the supply path of the switching signal and a positive potential point, and
wherein the time constant circuit comprises a series circuit of a resistor and a capacitor connected in series with the supply path of the switching signal.

5. The diode switch circuit according to claim 1, further including transistors each having an emitter connected to a positive potential point through a resistor, a collector connected to a negative potential point through a resistor and a base supplied with the switching signal,
wherein the snubber circuit comprises a series circuit of a resistor and a capacitor connected in parallel between the base of the transistor and the positive potential point, and
wherein the time constant circuit comprises a series circuit of a resistor and a capacitor connected in series with a path extending from the collector of the transistor and the PIN diode.

6. A switching circuit comprising:
a plurality of diode switch circuit units of systems for using PIN diodes as switch elements and supplying switching signals each changed stepwise to the switch elements to thereby allow the switch elements to perform switching operations; and
a switching signal cooperating circuit inputted with switching signals for the respective diode switch circuit units,
wherein the switching signal cooperating circuit disperses timings of switching signals outputted to the respective units according to the input switching signals and performs switching operations of the diode switch circuit units at timings different every unit.

7. The switching circuit according to claim 6, further including snubber circuits and time constant circuits provided in supply paths of the switching signals for the respective diode switch circuit units,
wherein each of the snubber circuits absorbs a spike-like high voltage contained in each of the switching signals, and
wherein each of the time constant circuits makes a change in the switching signal gentle.

8. The switching circuit according to claim 7, wherein the snubber circuit comprises a series circuit of a resistor and a capacitor connected between the supply path of the switching signal and a positive potential point, and
wherein the time constant circuit comprises a series circuit of a resistor and a capacitor connected in series with the supply path of the switching signal.

9. A switching circuit comprising:
a first unit group and a second unit group each including a plurality of diode switch circuit units of systems for using PIN diodes as switch elements and supplying switching signals each changed stepwise to the switch elements to thereby allow the switch elements to perform switching operations;
a first switching signal cooperating circuit inputted with switching signals for the respective units of the first unit group; and
a second switching signal cooperating circuit inputted with switching signals for the respective units of the second unit group,
wherein the first switching signal cooperating circuit disperses timings of the switching signals outputted to the respective units of the first unit group according to the switching signals inputted to the respective units of the first unit group and performs switching operations of the units of the first unit group at timings different at the respective units, and
wherein the second switching signal cooperating circuit disperses timings of the switching signals outputted to the respective units of the second unit group according to the switching signals inputted to the respective units of the second unit group and performs switching operations of the units of the second unit group at timings different at the respective units.

10. The switching circuit according to claim 9, further including snubber circuits and time constant circuits respectively provided in supply paths of the switching signals for the respective units of the first unit group and the second unit group,
wherein each of the snubber circuits absorbs a spike-like high voltage contained in each of the switching signals, and
wherein each of the time constant circuits makes a change in the switching signal gentle.

11. The switching circuit according to claim 10, wherein the snubber circuit comprises a series circuit of a resistor and a capacitor connected between the supply path of the switching signal and a positive potential point, and
wherein the time constant circuit comprises a series circuit of a resistor and a capacitor connected in series with the supply path of the switching signal.
